(19) United States
(12) Patent Application Publication
(10) Pub. No.: US 2018/0365703 A1
(43) Pub. Date: Dec. 20, 2018

(54) SYSTEMS AND METHODS FOR MICRO-CERTIFICATION

(71) Applicant: Integrated Media Technologies, Inc., North Hollywood, CA (US)

(72) Inventors: George Vytautas Tamas, Santa Barbara, CA (US); Robert Matthew Kobrin, Ventura, CA (US); Jeffrey D. Billings, North Hollywood, CA (US)

(73) Assignee: Integrated Media Technologies, Inc., North Hollywood, CA (US)

(21) Appl. No.: 16/010,353

(22) Filed: Jun. 15, 2018

Related U.S. Application Data
(60) Provisional application No. 62/520,470, filed on Jun. 15, 2017.

(51) Int. Cl. G06Q 30/00; G06F 17/30

(52) U.S. Cl. CPC G06Q 30/018; G06F 17/30598

(57) ABSTRACT

A plurality of certificate catalogues are stored, each certificate catalogue comprising one or more certificate templates, each certificate catalogue associated with a respective issuer. A plurality of certificate data records are stored, each certificate data record of the plurality of certificate data records identifying a learner and a learning outcome, each certificate data record of the plurality of certificate data records being generated based on a corresponding certificate template. Parent and Child relationships between certificates are recorded as links between certificate data records. A set of certificates can be arranged hierarchically according to their parent and child relationships. A certificate plan is obtained, the certificate plan comprising a set of one or more particular certificate templates. The set of one or more particular certificate templates is compared with a portion of the plurality of certificate data records, the portion of the plurality of certificate data records comprising the certificate data records identifying a particular learner. One or more gaps in the certificate plan are determined based on the comparison. The one or more gaps in the certificate plan are presented through a graphical user interface.

### CROSS REFERENCE TO RELATED APPLICATIONS

This application is a nonprovisional of and claims priority to U.S. Patent Application Ser. No. 62/520,470, filed Jun. 15, 2017, entitled “Hierarchical Credential Platform And Architecture,” which is incorporated by reference herein.

### TECHNICAL FIELD

This disclosure relates to approaches for generating, aggregating, and analyzing digital certificates.

### DESCRIPTION OF RELATED ART

Under conventional approaches, certificates (e.g., digital certificates) have traditionally been issued by a variety of different systems and entities, such as educational systems, and corporate systems. Typically, certificates may be generated and issued based on satisfaction of certificate criteria. However, traditional certificates lack the flexibility and/or the necessary level of granularity to sufficiently describe and/or track certificate progressions (e.g., progress towards earning an academic degree), and traditional certificates may be forged, hacked, or spoofed. Certificates are presented out of context, without any relationship to any other learning outcomes or accomplishments.

### SUMMARY

A claimed solution rooted in computer technology overcomes problems specifically arising in the realm of computer technology. In various embodiments, a computing system is provided for aggregating and analyzing certificate data records to present and/or update dynamic hierarchical representations of certificates across a variety of different contexts (e.g., academic, professional, hobbies or interests, and the like), and facilitate issuance and processing of secure and/or verifiable certificates at varying levels of granularity.

Various embodiments of the present disclosure include systems, methods, and non-transitory computer readable media configured to store a plurality of certificate catalogues, each certificate catalogue comprising one or more certificate templates, each certificate catalogue associated with a respective issuer. A plurality of certificate data records are stored, each certificate data record of the plurality of certificate data records identifying a learner and a learning outcome, each certificate data record of the plurality of certificate data records being generated based on a corresponding certificate template. A certificate plan is obtained, the certificate plan comprising a set of one or more particular certificate templates. The set of one or more particular certificate templates is compared with a portion of the plurality of certificate data records, the portion of the plurality of certificate data records comprising the certificate data records identifying a particular learner. One or more gaps in the certificate plan are determined based on the comparison. The one or more gaps in the certificate plan are presented through a graphical user interface.

In some embodiments, a first portion of the certificate data records identifying the particular learner are associated with a first issuer, and a second portion of the certificate data records identifying the particular learner are associated with a second issuer.

In some embodiments, each of the plurality of certificate data records comprises a respective data structure, each respective data structure including one or more parameters to facilitate generation of a corresponding certificate, and at least a portion of the respective data structures including an indication of any of one or more parent certificate data records and one or more child certificate data records.

In some embodiments, the systems, methods, and/or computer-readable media are configured to identify a particular certificate data record of the plurality of certificate data records; generate a particular certificate based on the particular certificate data record, the particular certificate indicating a particular learner and a particular learning outcome, and including a first link to the particular certificate data record, and including a second link to a particular child certificate data record of the of the particular certificate data record; and provide the particular certificate to a learner system associated with the particular learner.

In some embodiments, the particular certificate is immutable.

In some embodiments, the first link and the second link each comprise a respective permanent link.

In some embodiments, the systems, methods, and/or computer-readable media are configured to receive a request for a profile of the particular learner; organize, in response to the request for the profile of the particular learner, at least a portion of the plurality of certificate data records based upon any of the indicated child certificate data records and the indicated parent certificate data records of the one or more certificate data records identifying the particular learner; generate, in response to the organizing at least the portion of plurality of certificate data records, the profile of the particular learner; and present the profile of the particular learner.

In some embodiments, the profile of the particular learner includes a representation of the certificate plan.

In some embodiments, the profile of the particular learner includes a representation of the one or more gaps of the certificate plan.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the technology are utilized, and the accompanying drawings of which:

FIG. 1 depicts a diagram of an example of a dynamic hierarchy certificate system according to some embodiments.

FIG. 2 depicts a diagram of an example of an issuer system according to some embodiments.

FIG. 3 depicts a diagram of an example of an aggregator system according to some embodiments.

FIG. 4 depicts a diagram of an example of a learner system according to some embodiments.

FIG. 5 depicts a flowchart of an example of a method of operation of a dynamic hierarchy certificate system according to some embodiments.

FIG. 6 depicts a flowchart of an example of a method of comparing learner credentials to a plan according to some embodiments.

FIG. 7 depicts a flowchart of an example of a method of processing query requests according to some embodiments.

FIGS. 8A-E depict example graphical user interfaces according to some embodiments.

FIG. 9 depicts a diagram of an example of a computer system which may be specifically configured to implement any of the embodiments described herein.

### DETAILED DESCRIPTION

In various embodiments, certificates are provided for recording and communicating learning outcomes for learners. For example, learning outcomes may include completed academic degrees and coursework, professional certifications, and/or other abilities, accomplishments, and/or experiences. As used herein, a certificate may refer to a digital certificate and/or one or more data structures used to generate a digital certificate.

In the past, traditional certificates have been presented as a singular fixed occurrence in isolation. In some embodiments herein, the certificates describe dynamic relationships between certificates, as well as associated learning outcomes that can cross one or more contexts (e.g., academic, professional, hobbies or interests, and the like). For example, a certificate (e.g., an academic degree) may be related to one or more lower-order (or, “child”) certificates (e.g., an academic course, a professional course) and/or one or more higher-order (or, “parent”) certificates (e.g., an expert-level certification). Lower-order certificates may be certificates which lead up to the award of a particular certificate, and higher-order certificates may be certificates that follow a particular certificate or set of certificates.

It will be appreciated that in some embodiments the hierarchies described herein are dynamic (e.g., as opposed to fixed). Accordingly, a particular certificate may vary in order depending on circumstance. For example, a particular academic course certificate may be the highest-order certificate until an associated degree certificate is earned, at which point the particular academic course certificate may become a lower-order certificate relative to the associated degree certificate.

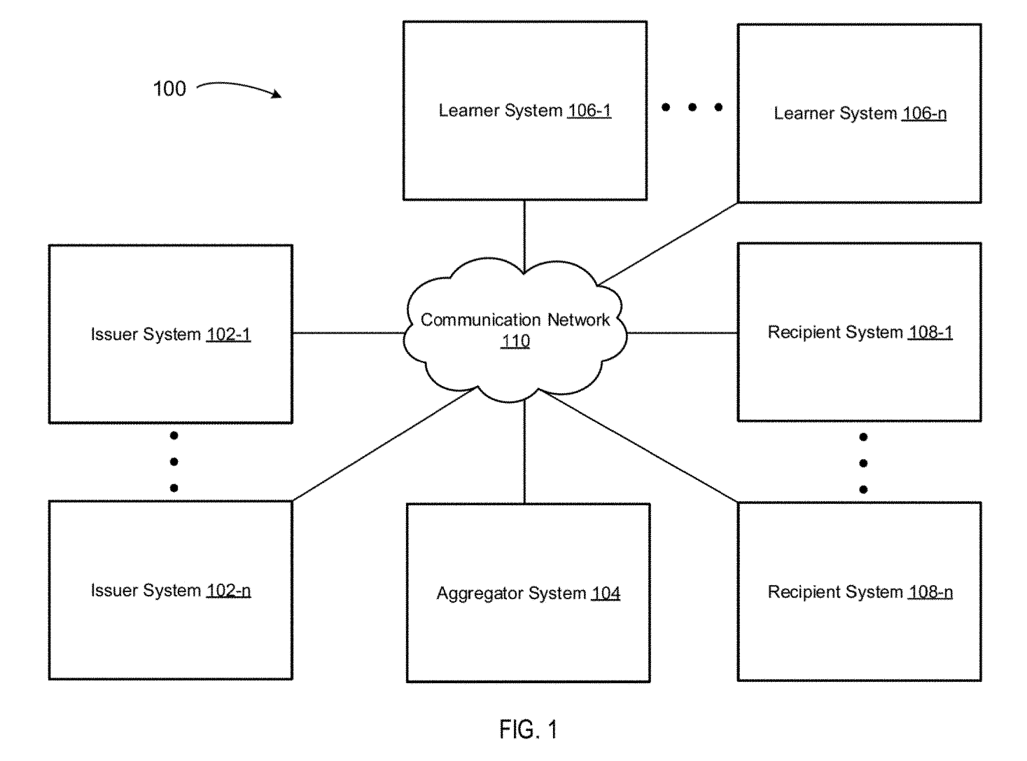

FIG. 1 depicts a diagram of an example of a dynamic certificate system 100 according to some embodiments. The example system 100 shown in FIG. 1 includes issuer systems 102-1 to 102-n (individually, the issuer system 102, collectively, issuer systems 102), an aggregator system 104, learner systems 106-1 to 106-n (individually, the learner system 106, collectively, the learner systems 106), recipient systems 108-1 to 108-n (individually, the recipient system 106, collectively, the recipient systems 106), and a communication network 110.

The issuer systems 102 may function to generate, store, and/or provide certificate catalogues and/or certificate data records. In various embodiments, the functionality of the issuer systems 102 may be performed by one or more servers, workstations, desktop computers, laptop computers, mobile devices (e.g., smartphone or tablet computer), and/or other computing devices. In some embodiments, functionality of the issuer system 102 may be implemented by one or more computing devices implementing one or more other systems described herein. In some embodiments, the issuer system 102 may comprise a portion of a “serverless” computing system. For example, the issuer system may 102 be implemented by one or more virtual machines and/or containers executing in a cloud-computing environment.

In some embodiments, a certificate catalogue (or, “catalogue”) comprises a set of certificate templates. A certificate template may represent a certificate offering (e.g., a particular academic degree, particular courses) offered by an issuer system 102. A certificate template may comprise a data structure and/or set of parameters that may be used to generate certificate data records. For example, a certificate data record may comprise a data structure including the structure and/or parameters of an associated certificate template, along with assigned parameter values and/or assigned certificate relationships (e.g., parent and/or child). In some embodiments, a certificate catalogue comprises all of the certificate templates associated with an issuer system 102. In various embodiments, certificate catalogues and/or certificate data records may be exported from a third-party implementation of the issuer system 102 to a custom and/or proprietary API, and/or or via an open source API, to the aggregator system 104.

The aggregator system 104 may function to aggregate certificate templates and/or certificate data records, and generate certificates. For example, functionality of the aggregator system 104 may be performed by one or more servers, mobile devices (e.g., smartphones, cell phones, smartwatches, tablet computers, and/or the like), desktop computers, laptop computers, workstations, and/or the like. In some embodiments, functionality of the aggregator system 104 may be implemented by one or more computing devices implementing one or more other systems described herein. In some embodiments, the aggregator system 104 may comprise a portion of a “serverless” computing system. For example, the aggregator system 104 may be implemented by one or more virtual machines executing in cloud-computing environment.

In some embodiments, the aggregator system 104 functions to generate certificates from certificate data records. A certificate may provide a secure and/or verifiable representation of a learning outcome, and may indicate one or more child certificates and/or parent certificates. For example, a certificate may be issued for an “Electrical Engineering Degree from Boston University”, and the certificate may indicate one or more child certificates (e.g., “Electrical Engineering 101”). Certificates may be immutable. The aggregator system 104 may provide certificates to other systems (e.g., learner systems 106 and recipient systems 108).

In some embodiments, a certificate may include one or more links. For example, the certificate may comprise a PDF document, and the one or more links may comprise Uniform Resource Locator (URL) links. Activating a link may direct a web browser, or other application, to connect to a specific computer system on a network, public or private, and request a particular certificate data record be returned. That computer system, physical or virtual, may serve the messages to present a Graphical User Interface (GUI), with the particular certificate data record and/or corresponding certificate. The GUI may present a page representing the information of the originating certificate plus additional data, including links to other relevant certificate data records (e.g., child and/or parent certificate data records). Accordingly, a user may drill-down or drill-up on a certificate to view lower-order and/or higher-order certificates and/or certificate data records.

In some embodiments, the aggregator system 104 functions to generate and/or store plans. A plan may comprise a set of one or more certificate templates. Plans may be predefined and/or user defined. The aggregator system 104 may generate a plan based on input received from an administrator, learner, and/or the like. For example, a particular issuer system 102 associated with a university may predefine a plan for earning an “Electrical Engineering Degree” certificate from that university, or a learner may define a plan for a “Master Engineer” certificate, and select certificate templates associated with any number of different issuers and/or contexts.

In some embodiments, the aggregator system 104 functions to continuously/regularly/periodically/intermittently (or according to some other schedule) track and/or monitor plans. For example, the aggregator system 102 may compare the plan, or more particularly, the certificate templates of the plan, with a set of corresponding certificate data records, and (i) notify a learner upon earning a particular certificate associated with a plan, (ii) identify anticipated dates for completing a plan, (iii) identify gaps in plans (e.g., particular courses that still need to be completed in order to satisfy a particular plan), and/or recommend certificates (e.g., degrees, courses, tasks, and/or the like) for satisfying gaps in a plan.

In some embodiments, the aggregator system 104 functions to dynamically generate and/or provide a profile of a learner and/or a set of learners. A profile may represent some or all of the certificates earned by a learner as of a particular point in time (e.g., a current time), and the relationships between the certificates as of the particular point in time. Profiles may be created and/or updated in real-time and/or on-demand. For example, profiles may be created and/or updated in real-time in response to one or more events (e.g., earning an additional certificate).

In some embodiments, a profile may represent a dynamic hierarchy of certificates earned by a learner. For example, a dynamic hierarchy may include a first order of certificates (e.g., academic degrees, professional certifications, job titles, and the like), a second order of certificates (e.g., courses required to obtain a particular academic degree or professional certification, jobs or tasks required to earn a particular job title, and the like), a third order of certificates (e.g., topics completed within a particular course or certification, particular skills completed within a particular job, and the like), a fourth order (e.g., competencies required for particular topics, tasks required for particular jobs, and the like), and so forth. Lower-order certificates may be referred to as subordinate certificates, and higher-order certificates may be referend to superior certificates.

The profile and/or dynamic hierarchy may be changed automatically (e.g., in response to a learner earning additional certificates). For example, a dynamic hierarchy may represent academic coursework certificates as a first order of certificates before a corresponding academic degree certificate is earned, and a subsequent dynamic hierarchy may represent the coursework certificates as a second order of certificates after the corresponding academic degree certificate has been earned.

The learner systems 106 may function to store, install and/or execute applications (e.g., mobile applications, web browsers, and the like), present graphical user interfaces (GUIs), receive user inputs, and communicate with remote systems. For example, the learner systems 106 may receive and display certificates, display dynamically generated profiles, and/or the like. In some embodiments, functionality of the learner systems 106 may be performed by one or more mobile devices (e.g., smartphones, cell phones, smartwatches, tablet computers, and/or the like), desktop computers, laptop computers, workstations, servers, and/or the like. In some embodiments, the learner system 106 implement third-party applications (e.g., Adobe PDF reader or the like) to view certificates with or without communication with one or more of the other systems described herein.

The recipient systems 108 may function to receive, store, and/or present certificates. For example, recipient systems 108 may comprise social media systems, such as Facebook, LinkedIn, and the like, which can present certificates on a learner's account. Recipients may use the recipient systems 108 to view more levels of detail on the certificates, e.g., by navigating to view certificate data records stored on the aggregator system 104.

The communication network 110 may represent one or more computer networks (e.g., LAN, WAN, and/or the like) or other transmission mediums. The communication network 110 may provide communication between the issuer systems 102, the aggregator system 104, the learner systems 106, the recipient systems 108, and/or other systems and/or or components thereof described herein. In some embodiments, the communication network 110 comprises one or more computing devices, routers, cables, buses, and/or other network topologies (e.g., mesh, hub-and-spoke, and/or the like). In some embodiments, the communication network 110 may be wired and/or wireless. In various embodiments, the communication network 110 may comprise the Internet, one or more wide area networks (WANs) or local area networks (LANs), one or more networks that may be public, private, IP-based, non-IP based, and so forth.

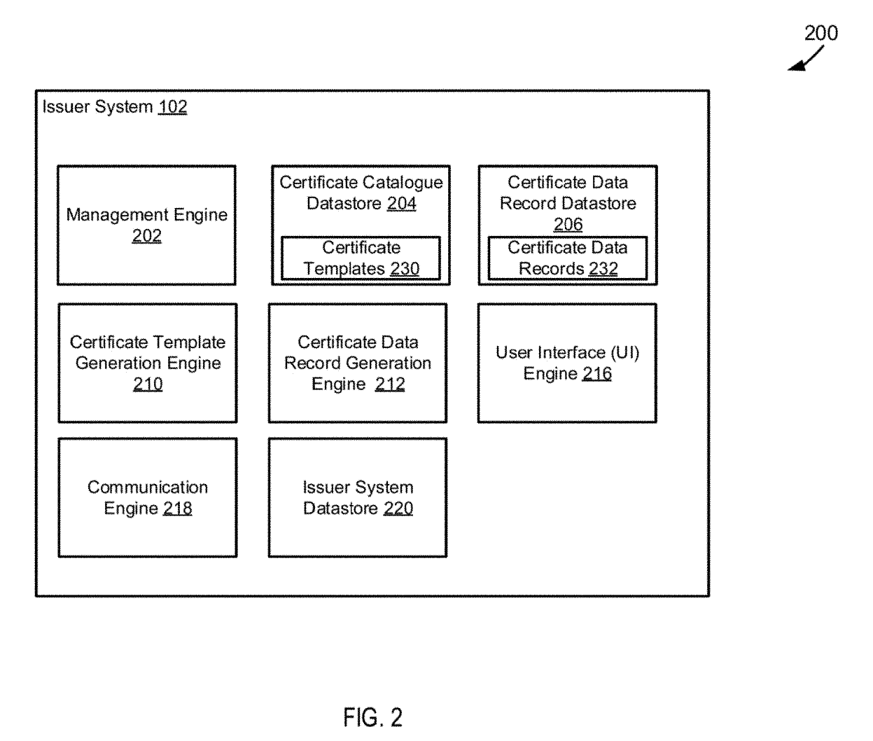

FIG. 2 depicts a diagram 200 of an example of an issuer system 102 according to some embodiments. The issuer system 102 includes management engine 202, a catalogue datastore 204, a certificate data record datastore 206, a certificate template generation engine 210, a certificate data record generation engine 212, a user interface (UI) engine 216, a communication engine 218, and an issuer system datastore 220. Like the other systems described herein, the issuer system 102 may include more or less functionality than described here. For example, the issuer system 102 may include some or all of the functionality of one or more other systems (e.g., aggregator system 102 and/or learner system 106).

The management engine 202 may function to manage (e.g., create, read, update, delete, or otherwise access) certificate templates 230 stored in the catalogue datastore 204, and/or certificate data records 232 stored in the certificate data record datastore 206. The management engine 202 may perform any of these operations manually (e.g., by a user interacting with a GUI) and/or automatically (e.g., triggered by one or more of the engines 210-218, discussed below). In some embodiments, the management engine 202 comprises a library of executable instructions, which are executable by one or more processors for performing any of the aforementioned management operations.

The certificate templates 230 may define a set of parameters for generating certificate data records 232. For example, a university may define a particular certificate templates 230 corresponding to a particular academic degree (e.g., an electrical engineering degree), particular coursework, and/or the like. In some embodiments, certificate templates 230 may store some or all of the following parameters, some or all of which may have an unassigned (or, NULL) value or a predefined assigned value:
Template Identifier: identifies the stored certificate template.
Certificate Template Tag(s): tag(s) for identifying equivalent certificate template. For example, each tag may be linked to, or otherwise indicate, one or more sets of equivalent certificate templates. For example, an issuer may indicate one or more certificate templates that are equivalent with their own certificate templates. In some embodiments, a template set of equivalent certificates template tags may be created. For example, the template set may include a “Basic Engineering” tag and different issuers may apply a template tag to their certificate templates, which may facilitate determining equivalencies across different issuers and/or contexts.
Certificate Template Title: title of certificate, course and/or award.
Issuer ID
Issuer Name
Learner ID
Status: status of certificate, e.g., enrolled, in progress, completed, and/or the like.
Other Attribute Fields: other attribute/parameter fields that will be used for the corresponding certificate data record. For example, a “EE 101” certificate may include course ID, instructor ID, test IDs, grade/evaluation for the course, and/or the like.

The certificate data records 232 may be generated using a certificate template 230. For example, the certificate data records 232 may include information for courses completed at a university, such as course names, grades obtained, dates of attendance, and the like. In some embodiments, a certificate data record 232 may be associated with an issuer system 102 and a learner system 106, and may comprise values for some or all attributes of a certificate template 230. More specifically, the certificate data records 232 may include values for some or all of the attributes of a corresponding certificate template 230. For example, certificate data records 232 may store some or all of the following attributes:
Certificate Data Record ID
Description: description of a certificate (e.g., electrical engineering degree)
Comments: comments or other data (e.g., comments by an instructor)
Sub-certificates (or, “children”): one or more certificates required to complete the associated certificate. For example, an electrical engineering degree certificate may have a fundamental physics sub-certificate. Each sub-certificate itself may also be a certificate. These may defined dynamically and/or statically.
Superior certificates (or, “parent”): one or more certificates that include the certificate as a child. These may defined dynamically and/or statically.
Permissions: controls access to sub-certificates. For example, permissions may limit third-party entities (e.g., recipient systems) to drilling down in the hierarchy, as opposed to up the hierarchy and/or laterally.
Learning Outcome: a current learning outcome (e.g., intention to enroll, enrolled, completed, passed, failed, grade achieved, timestamp)

In some embodiments, the certificate data records 232 may be generated using a domain-specific language (e.g., XML) or other language and/or format.

The certificate template generation engine 210 may function to generate certificate templates 230. The certificate template generation engine 210 may be generate certificate templates 230 in response to user input (e.g., an administrator defining attributes, acceptable attribute values and/or value ranges, and the like) and/or automatically (e.g., from a predetermined template).

The certificate data record generation engine 212 may function to generate certificate data records 232. For example, the certificate data records 230 may include values for some or all of the attributes of a certificate template. In some embodiments, certificate data records 230 are generated in response to completion of a certificate and/or a portion of a certificate. The certificate data record generation engine 212 may update or otherwise maintain certificate data records 232, e.g., to retroactively edit information and/or add additional information.

In some embodiments, the certificate data record generation engine 212 generates and/or provides certificate data records 230 in response to satisfaction of a certificate condition associated with a particular learner. For example, a certificate condition may include providing certificate data records at predetermined intervals, and/or when a certificate is earned.

The user interface engine 216 may function to provide graphical user interfaces, receive user input, and the like. In some embodiments, user interface engine 216 receives specifications for certificate templates 210. For example, specifications may be received from administrators of the issuer system 102.

The communication engine 218 may function to send requests, transmit and, receive communications, and/or otherwise provide communication with one or a plurality of systems. In some embodiments, the communication engine 226 functions to encrypt and decrypt communications. The communication engine 226 may function to send requests to and receive data from a system through a network or a portion of a network. Depending upon implementation-specific or other considerations, the communication engine 226 may send requests and receive data through a connection, all or a portion of which may be a wireless connection. The communication engine 226 may request and receive messages, and/or other communications from associated systems

The issuer system datastore 220 may function to store, at least temporarily, data received from one or more other systems. For example, the issuer system datastore 220 may store messages received by the communication engine 218. Like other datastores described herein, the issuer system datastore 220 may reside local to the issuer system datastore 220, or comprise a remote storage system (e.g., a cloud storage system).

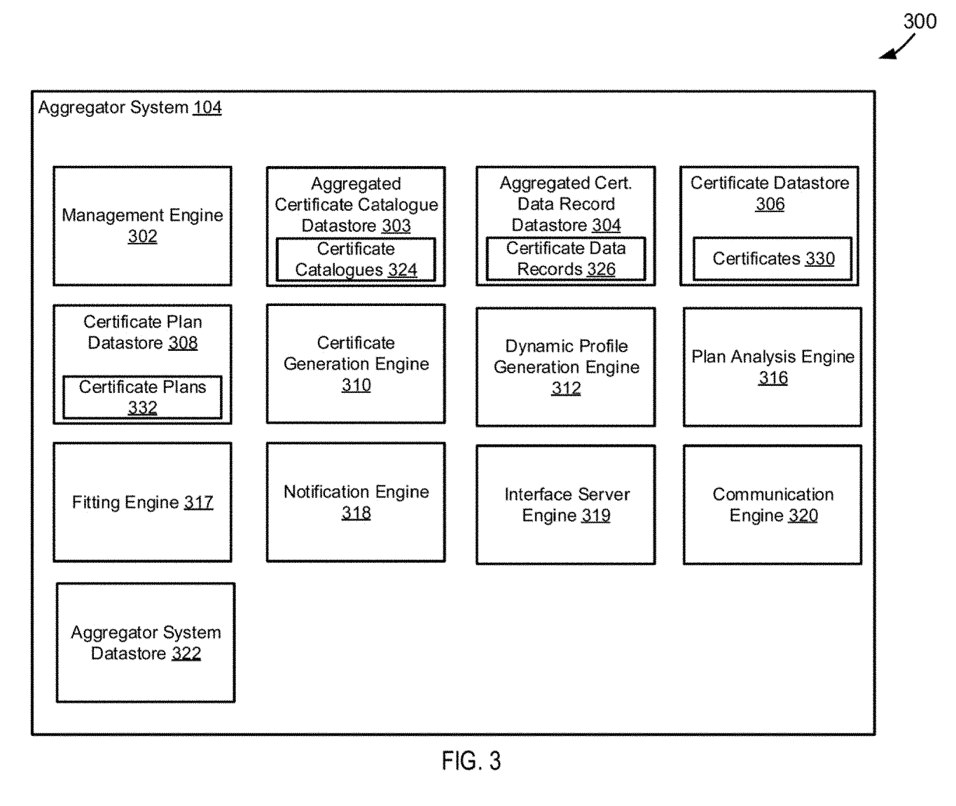

FIG. 3 depicts a diagram 300 of an example of an aggregator system 104 according to some embodiments. The aggregator system 104 includes a management engine 302, an aggregated catalogue datastore 303, an aggregated certificate data record datastore 304, a certificate datastore 306, a certificate plan datastore 308, a certificate generation engine 310, a dynamic profile engine 312, a plan analysis engine 316, a fitting engine 317, a notification engine 318, an interface server engine 319, a communication engine 320, an aggregator system datastore 322. Like the other systems described herein, the aggregator system 104 may include more or less functionality than described here. For example, the aggregator system 104 may include some or all of the functionality of one or more other systems (e.g., issuer system 102 and/or learner system 106).

The management engine 302 may function to manage (e.g., create, read, update, delete, or otherwise access) certificate catalogues 324 stored in the aggregator certificate catalogue datastore 303, certificate data records 232 stored in the aggregated certificate data record datastore 304, certificates 330 stored in the certificate datastore 306, and/or certificate plans 332 stored in the certificate plan datastore 308. The management engine 302 may perform any of these operations manually (e.g., by a user interacting with a GUI) and/or automatically (e.g., triggered by one or more of the engines 310-320, discussed below). In some embodiments, the management engine 302 comprises a library of executable instructions, which are executable by one or more processors for performing any of the aforementioned management operations.

The certificate catalogues 324 may each include one or more certificate templates. The certificate catalogues 324 may be obtained from one or more issuer systems 102. For example, the certificate catalogues 324 may include certificate catalogues comprising certificate templates 230 obtained from different issuer systems 102.

The certificates 330 may be generated from one or more corresponding certificate data records 326. The certificate data records 326 may be obtained from any number of issuers across any number of contexts. For example, the certificate data records 326 may include certificate data records 232 obtained from one or more issuer systems 102. Certificates 330 may be immutable and/or partially immutable. In some embodiments, the certificates 330 may include some or all of the following:
Certificate ID
Description: description of the certificate (e.g., electrical engineering degree)
Issuer: issuer of the certificate (e.g., “Stanford”)
Learning Outcome: a current learning outcome (e.g., enrolled, completed, passed, failed, grade achieved, timestamp)
Link(s): links (e.g., permanent links, hyperlinks) to corresponding certificate data records, sub-certificates, and/or superior certificates.
Sub-certificates (or, “children”): one or more certificates required to complete the associated certificate. For example, an electrical engineering degree certificate may have a fundamental physics sub-certificate. Each sub-certificate itself may also be a certificate. These may defined dynamically and/or statically.
Superior certificates (or, “parent”): one or more certificates that include the certificate as a child. These may defined dynamically and/or statically.
Permissions: controls access to sub-certificates. For example, permissions may limit third-party entities (e.g., recipient systems) to drilling down in the hierarchy, as opposed to up the hierarchy and/or laterally.

The certificates 330 may comprise viewable documents (e.g., a PDF document) including a certificate title, a certificate issuer, and the like. For example, a particular academic certificate 330 may comprise a PDF document indicating university name, learner name, type of degree, and the like, and include link to certificate data records 326 satisfying the particular academic degree certificate.

In some embodiments, certificates 330 may include links (e.g., Uniform Resource Locator links, permanent links). The links may link to certificate data records 326, and/or portions thereof. For example, a recipient system 108 may receive a certificate 330, and drill-down on portions of the certificate 330 to view or access the linked certificate data records 326, and/or portions thereof. This may help, for example, ensure a recipient system 108 obtains a valid certificate without requiring complicated validation procedures, and also allow the recipient system 108 to drill-down on a certificate 234 to receive further information (e.g., information of sub-certificates, such as course work taken to complete the degree).

The certificate plans 332 may each include one or more certificate templates (e.g., certificate templates 230). Certificate plans may be defined by issuers and/or learners. For example, a university may define a certificate plan 332 for a particular degree, or a learner may define a certificate plan 332 for desired set of certificates and/or a desired goal. A certificate plan 332 may include certificate templates associated with different issuers and/or contexts. For example, a certificate plan 332 may include one or more certificates templates 232 associated with a particular issuer, and certificate templates 232 associated with a different issuer. Certificate plans 332 may be created and/or selected through the aggregator system 102.

In some embodiments, certificate plans 332, certificates 330, and/or certificate data records 326 may indicate a learner's (i) intention to achieve a certificate plan 332 and/or certificate 330, (ii) being in process (e.g., enrolled) of achieving a certificate plan 332 and/or certificate 330, and/or (iii) achieved (e.g., completed) a certificate plan 332 and/or certificate. For example, upon selecting and/or creating a particular certificate plan 332, the aggregator system 102 may update the particular plan 332, and/or associated certificate data records 326 and/or associated certificates 330, for a particular learner in order to indicate the particular learner's intention to achieve the particular certificate plan 332. As the particular learner progresses (e.g., by enrolling in courses of the particular plan 332, completing courses in the particular plan 332), the aggregator system 102 may update the particular plan 332, and/or associated certificate data records 326 and/or associated certificates 330, for the particular learner accordingly.

The certificate generation engine 310 may function to generate certificates 330. In some embodiments, the certificate generation engine 310 generates certificates 330 from one or more corresponding certificate data records 326. In some embodiments, certificates may be immutable and/or encrypted. The certificate generation engine 310 may generated certificates automatically and/or on-demand. For example, a certificate may be generated upon receipt of a corresponding certificate data record and/or when a corresponding certificate data record 326 indicates a particular learning outcome (e.g., a completed degree). In some embodiments, the certificate generation engine 310 generates certificates 330 across different issuers and/or contexts (e.g., military, academic, corporate, and the like).

The dynamic profile generation engine 312 may function to dynamically generate a current profile of a learner. The profile may represent a dynamic hierarchy of certificate data records 326 associated with a particular learner at a current time (e.g., when the profile is requested). Accordingly, the profile may change and update in real-time as certificates are earned. In some embodiments, certificates may be presented based on order. For example, lower-order certificates may be presented below higher-order certificates.

In some embodiments, the dynamic profile generation engine 312 dynamically generates a current profile of a learner by organizing and/or traversing certificate data records 326. For example, the certificate data records 326 associated with a particular learner may be identified, and then organized based on indicated child and/or parent certificate data records 326.

The plan analysis engine 316 may function to determine whether there are any certificate gaps for a certificate plan 332. In some embodiments, the plan analysis engine 316 may identify the set of certificate data records 326 of a learner, and compare the identified certificate data records 326 with a certificate plan 332. More specifically, the plan analysis engine 316 may compare the identified certificate data records 326 with the certificate templates of the certificate plan 332. Gaps may be determined from the certificate templates of the plan 332 that do not have corresponding (or, “matching”) certificate data records 326 of the learner indicating a particular learning outcome (e.g., passed).

In some embodiments, the plan analysis engine 316 determines one or more recommendations for satisfying certificate gaps. For example, the recommendations may comprise the missing certificate templates and/or equivalents thereof.

The fitting engine 317 may function to identify learners having a particular skillset (e.g., the learners having achieved one or more particular certificates 330 and/or certificate plans 332), learners having a portion of a particular skillset (e.g., the learners having achieved some of a set of particular certificates 330 and/or certificate plans 332), learners having a desired skillset (e.g., the learners enrolled or intending to enroll in one or more particular certificates 330 and/or certificate plans 332), and/or learners having a portion of a desired skillset (e.g., the learners enrolled or intending to enroll in some of a set of particular certificates 330 and/or certificate plans 332). For example, the fitting engine 317 may identify one or more learners based on search criteria (e.g., search criteria included in a request or other message).

In some embodiments, the fitting engine 317 may compare search criteria with some or all of the certificate data records 326, certificates 330, and/or certificate plans 332. If any learner matches a threshold value of the search criteria (e.g., 100%), the fitting engine 317 may return an identifier associated with that learner. A learner may match of a search criteria if a certificate data record 326 associated with that learner indicates a match. For example, search criteria may include “Electrical Engineering Degree,” the fitting engine 317 may return learner identifiers for learners associated with certificate data records 326 indicating they have earned an electrical engineering degree and/or equivalent certificate.

The notification engine 318 may function to generate alerts and/or other notification messages. Notifications messages may include email messages, text messages, and/or other electronic communication message. Notification messages may be generated in response to notification conditions. Notification conditions may include a learning outcome of a certificate data record 326, certificate 330, and/or certificate plan 332. For example, notifications may be generated in response to generation of a certificate 330, completing a plan 332, partially completing a plan 332, and so forth. Notifications may be generated in real-time, e.g., at the same, or substantially same time, a learning outcome is determined and/or modified (e.g., “enrolled” is modified to “completed”).

The interface server engine 319 may function to generate an interface for presenting and/or navigating dynamic hierarchical representations of certificate data records 326 and/or certificates 330. For example, the interface may be used to generate a web page that may be navigated by a learner system 106. In some embodiments, the dynamic hierarchical representations of certificate data records 326 and/or certificates 330 is generated on-demand and/or in real-time, thereby reflecting a current and/or changing hierarchy. For example, a user (e.g., learner) may view a higher-order certificate, drill-down to lower order certificates, drill-up to higher-order certificates, and so forth.

The communication engine 320 may function to send requests, transmit and, receive communications, and/or otherwise provide communication with one or a plurality of systems. In some embodiments, the communication engine 320 functions to encrypt and decrypt communications. The communication engine 320 may function to send requests to and receive data from a system through a network or a portion of a network. Depending upon implementation-specific or other considerations, the communication engine 320 may send requests and receive data through a connection, all or a portion of which may be a wireless connection. The communication engine 320 may request and receive messages, and/or other communications from associated systems.

The aggregator system datastore 322 may function to store, at least temporarily, data received from one or more other systems. For example, the aggregator system datastore 322 may store messages received from the communication engine 320. Like other datastores described herein, the aggregator system datastore 322 may reside local to the aggregator system, or comprise a remote storage system (e.g., a cloud storage system).

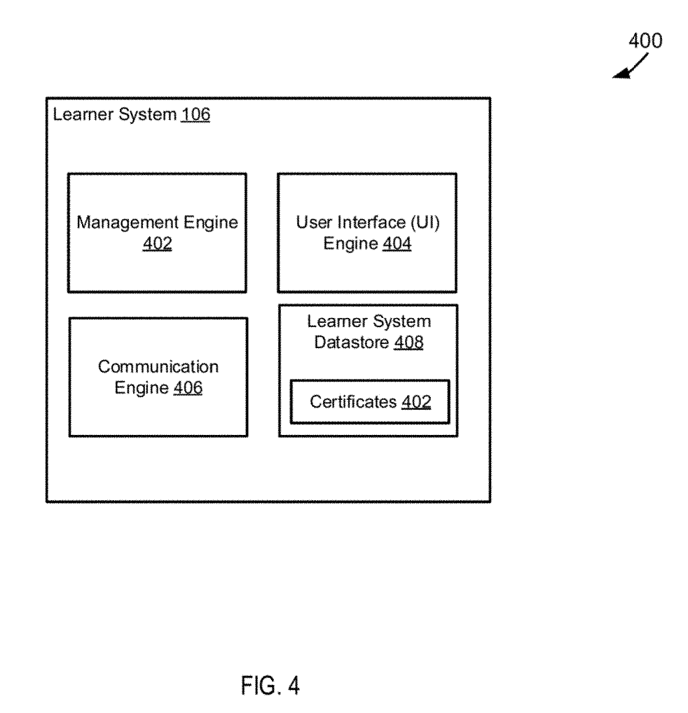

FIG. 4 depicts a diagram 400 of an example of a learner system 106 according to some embodiments. The learner system 106 may include a management engine 402, a user interface engine 404, a communication engine 406, and a learner system datastore 408.

The management engine 402 may function to manage (e.g., create, read, update, delete, or otherwise access) certificates 402. The management engine 402 may perform any of these operations manually (e.g., by a user interacting with a GUI) and/or automatically (e.g., triggered by one or more of the engines 402-406, discussed below). In some embodiments, the management engine 402 comprises a library of executable instructions, which are executable by a processor for performing any of the aforementioned management operations.

The user interface engine 404 may function to display, visualize, and/or otherwise present profiles of a learner, and/or certificates 402. For example, the user interface engine 404 may comprise a web browser or application. In some embodiments, the user interface engine 404 may cooperate with the interface server engine 319 to allow users to navigate dynamic hierarchies of certificates and/or certificate data records.

The communication engine 406 may function to send requests, transmit and, receive communications, and/or otherwise provide communication with one or a plurality of systems. In some embodiments, the communication engine 406 functions to encrypt and decrypt communications. The communication engine 406 may function to send requests to and receive data from a system through a network or a portion of a network. Depending upon implementation-specific or other considerations, the communication engine 406 may send requests and receive data through a connection, all or a portion of which may be a wireless connection. The communication engine 406 may request and receive messages, and/or other communications from associated systems

The learner system datastore 408 may function to store, at least temporarily, data received from one or more other systems. For example, the learner system datastore 408 may store messages received from the communication engine 406. Like other datastores described herein, the learner system datastore 408 may reside local to the learner system 106, or comprise a remote storage system (e.g., a cloud storage system). The learner system datastore 408 may function to store certificates 402.

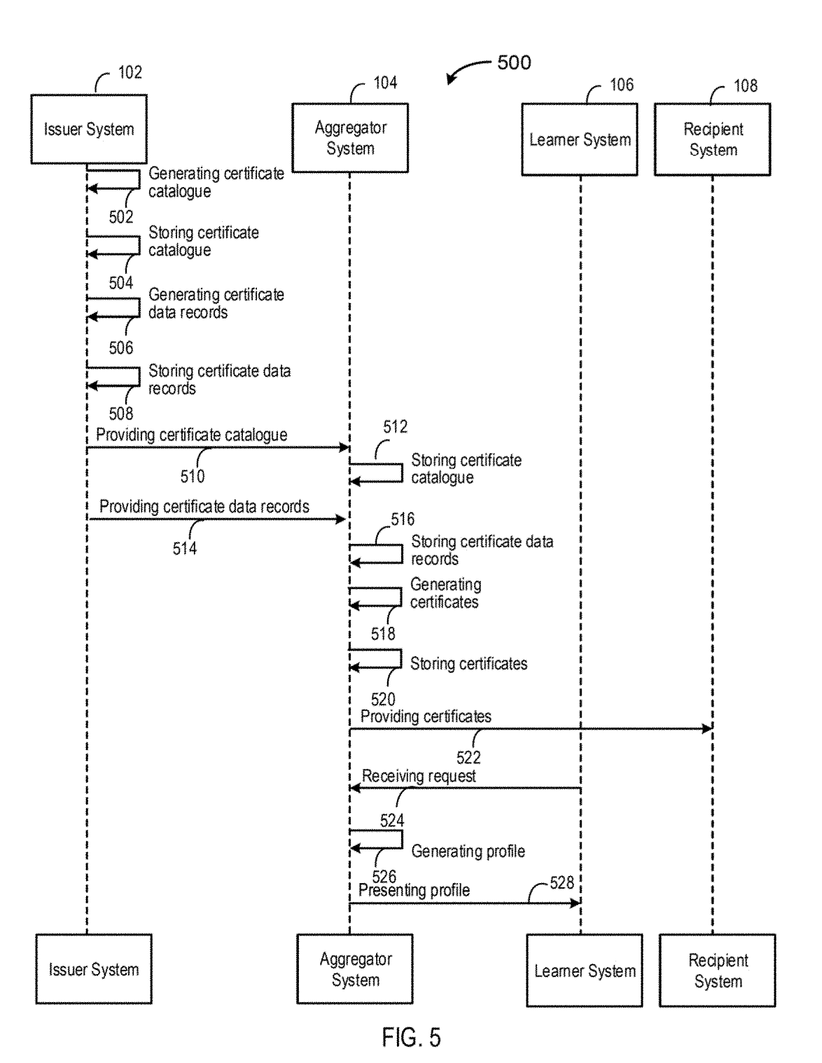

FIG. 5 depicts a flowchart 500 of an example of a method for aggregating certificate data records and providing learner profiles according to some embodiments. In this and other flowcharts, the flowchart illustrates by way of example a sequence of steps. It should be understood the steps may be reorganized for parallel execution, or reordered, as applicable. Moreover, some steps that could have been included may have been removed to avoid providing too much information for the sake of clarity and some steps that were included could be removed, but may have been included for the sake of illustrative clarity.

In step 502, an issuer system (e.g., issuer system 102) generates a certificate catalogue comprising certificate templates (e.g., certificate templates 230). In some embodiments, a certificate template generation engine (e.g., certificate template generation engine 210) generates the certificate catalogue and/or certificate templates.

In step 504, the issuer system stores the certificate catalogue. In some embodiments, an issuer management engine (e.g., management engine 202) stores the certificate catalogue in a catalogue datastore (e.g., catalogue datastore 204).

In step 506, the issuer system generates certificate data records (e.g., certificate data records 232. In some embodiments, a certificate data record generation engine (e.g., certificate data record generation engine 212) generates the certificate data records.

In step 508, the issuer system stores the certificate data records. In some embodiments, the issuer management engine stores the certificate data records in a certificate data record datastore (e.g., certificate data record datastore 206).

In step 510, the issuer system provides the certificate catalogue to an aggregator system (e.g., aggregator system 104). In some embodiments, the issuer communication engine provides the certificate catalogue over a communication network (e.g., communication network 110).

In step 512, the aggregator system stores the certificate catalogue. In some embodiments, the aggregator communication engine receives the certificate catalogue and/or the aggregator management engine stores the certificate catalogue in an aggregated catalogue datastore (e.g., aggregated catalogue datastore 303).

In step 514, the issuer system provides the certificate data records to the aggregator system. In some embodiments, the issuer communication engine provides the certificate data records over the communication network.

In step 516, the aggregator system stores the certificate data records. In some embodiments, the aggregator communication engine receives the certificate data records and/or the aggregator management engine stores the certificate data records in a certificate data record datastore (e.g., certificate data record datastore 304).

In step 518, the aggregator system generates certificates (e.g., certificates 234). In some embodiments, a certificate generation engine (e.g., certificate generation engine 310) generates the certificates.

In step 520, the aggregator system stores the certificates. In some embodiments, the aggregator management engine stores the certificates in a certificate datastore (e.g., certificate datastore 306).

In step 522, the aggregator system provides the certificates to a recipient system (e.g., recipient system 108). In some embodiments, an aggregator communication engine (e.g., communication engine 320) provides the certificates to the recipient system over a communication network (e.g., communication network 110).

In step 524, the aggregator systems received a request (e.g., a profile request) from a learner system (e.g., learner system 106). In some embodiments, the aggregator communication engine receives the request over the communication network.

In step 526, the aggregator system dynamically generates a profile of the learner in response to the request. In some embodiments, a dynamic profile generation engine (e.g., dynamic profile generation engine 312) dynamically generates the profile.

In step 528, the aggregator system presents the profile to the learner system. In some embodiments, an interface server engine (e.g., interface server engine 319) presents the profile.

Notably, the recipient system 108, similar to the learner system 106, can make requests and receive profiles from the aggregator 104.

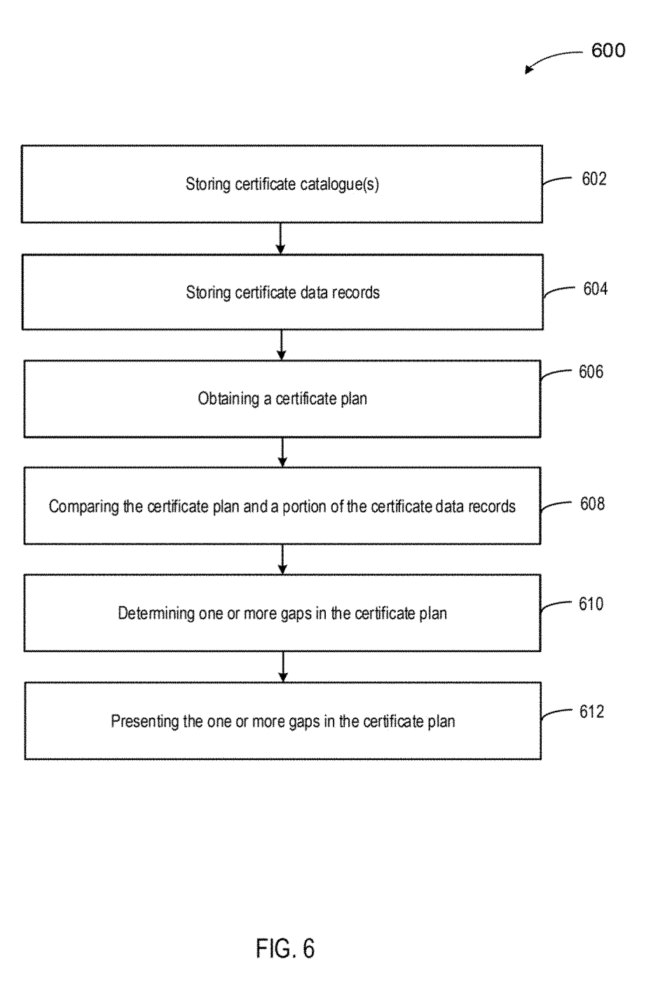

FIG. 6 depicts a flowchart 600 of an example of a method for comparing learner credentials to a plan according to some embodiments.

In step 602, an aggregator system (e.g., aggregator system 104) stores a plurality of certificate catalogues (e.g., catalogues 324). Each certificate catalogue may comprise one or more certificate templates. The certificate catalogues may be received from any number of issuers (e.g., issuers 102). Issuers may be of any context. In some embodiments, an aggregator communication engine (e.g., communication engine 320) receives the certificate catalogues over a communication network (e.g., communication network 110) and an aggregator management engine (e.g., management engine 320) stores the certificate catalogues in a datastore (e.g., aggregated catalogue datastore 303).

In step 604, the aggregator system stores a plurality of certificate data records (e.g., certificate data records 326). In some embodiments, the aggregator communication engine receives the certificate data records over the communication network and the management engine stores the certificate data records in a datastore (e.g., aggregated certificate data record datastore 304).

In step 606, the aggregator system obtains a certificate plan (e.g., a certificate plan 332). The certificate plan may comprise a set of one or more particular certificate templates. In some embodiments, a management engine (e.g., management engine 302) may obtain a certificate plan from a plan datastore (e.g., certificate plan datastore 308). Plans may be learner-defined and/or issuer-defined.

In step 608, the aggregator system compares the certificate plan and a portion of the plurality of certificate data records. In some embodiments, a plan analysis engine (e.g., plan analysis engine 316) performs the comparison.

In step 610, the aggregator system determines one or more gaps in the certificate plan based on the comparison. In some embodiments, the plan analysis engine performs the determination.

In step 612, the aggregator system presents the one or more gaps in the certificate plan. In some embodiments, an interface server engine (e.g., interface server engine 319) presents the one or more gaps. For example, the gaps may be presented as part of a GUI displaying a dynamically generated profile of a learner.

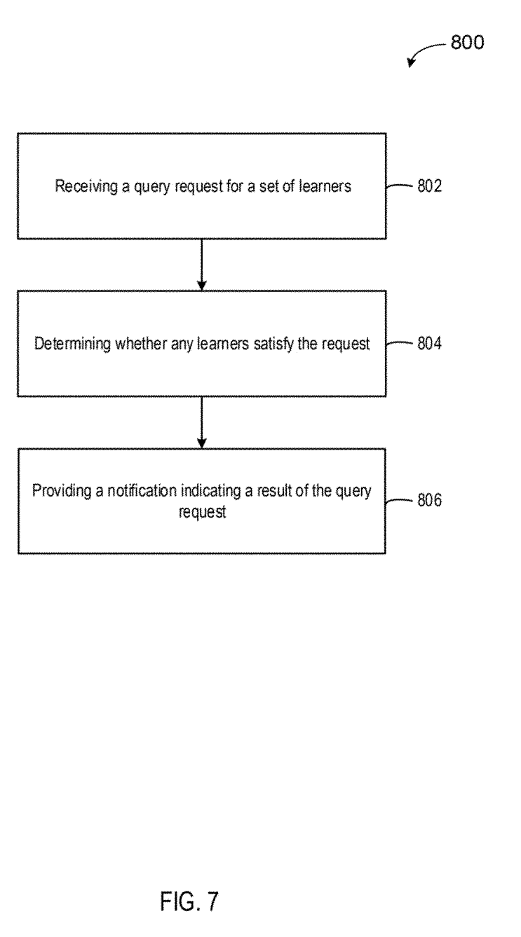

FIG. 7 depicts a flowchart 700 of an example of a method for processing query requests for candidate learners according to some embodiments.

In step 702, an aggregator system (e.g., an aggregator system 104) receives a query request for a set of learners. The query request may be received from a recipient system (e.g., recipient system 108) over a communication network (e.g., communication network 110). For example, the recipient system may be associated with an employer or recruiter, and the query request may comprise request for a for a list of candidate learners with particular skills.

In step 704, the aggregator system determines whether any learners satisfy the query request. In some embodiments, the aggregator system may compare the certificates (e.g., certificates 330) with the query request. In some embodiments, a fitting engine (e.g., fitting engine 222) determines whether any learners satisfy the query request.

In step 706, the aggregator system provides a notification indicating a result of the query request. For example, if at least one match is determined, the notification may include an identifier of the matching learner(s) and/or links to the certificates of the matching learner(s). If at least one match is not determined, the notification may indicate that no match has been found. In some embodiments, if no match is found, the aggregator system may determine near matches, and provide a notification indicating near matches.

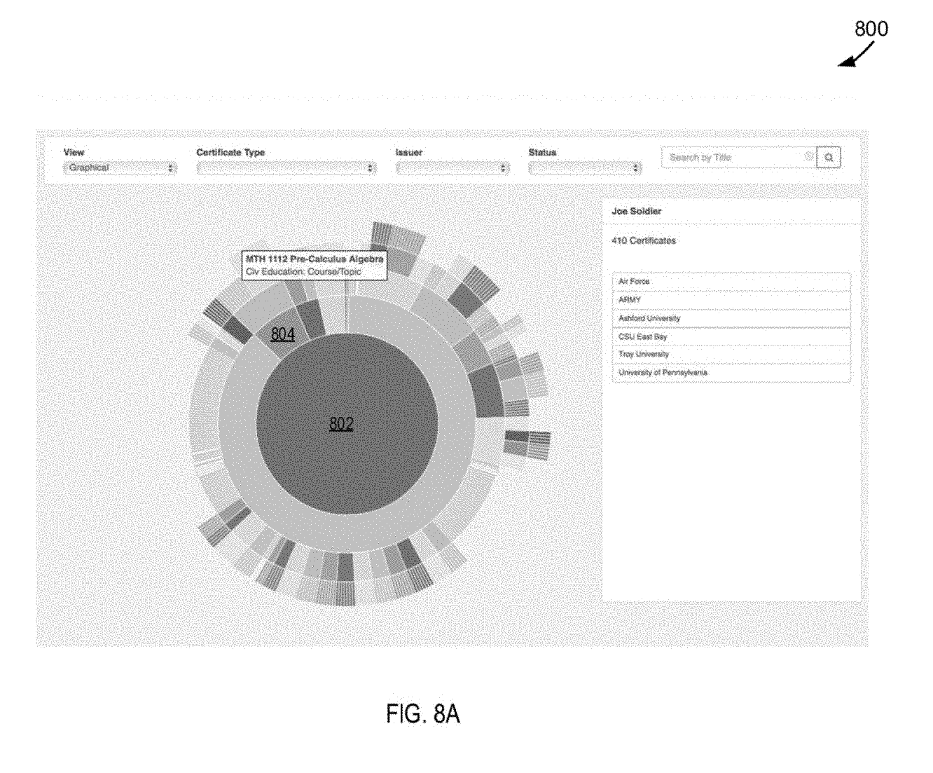

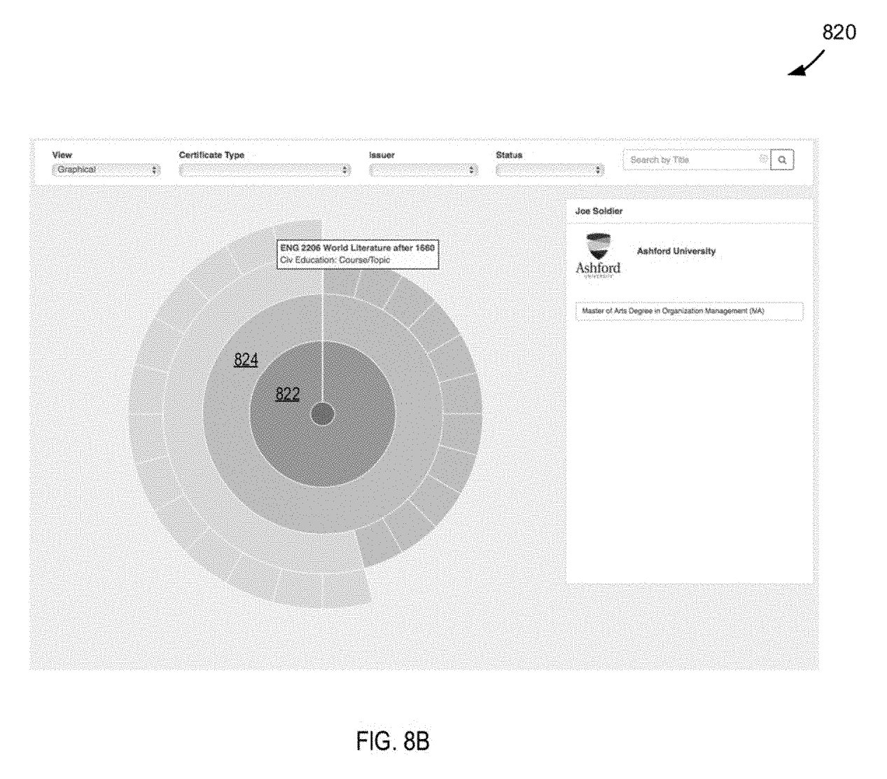

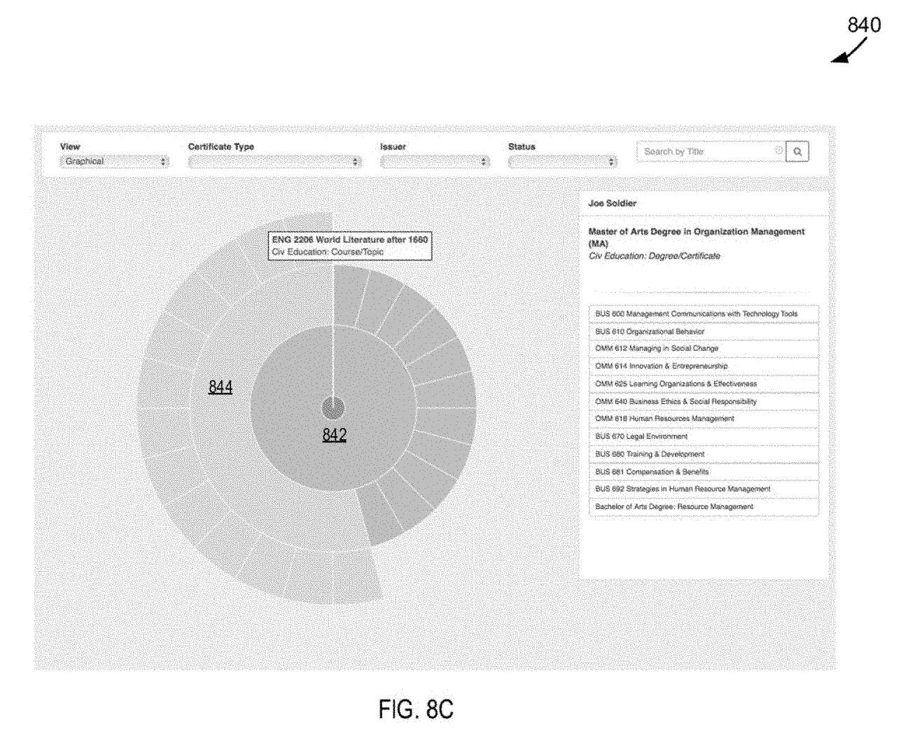

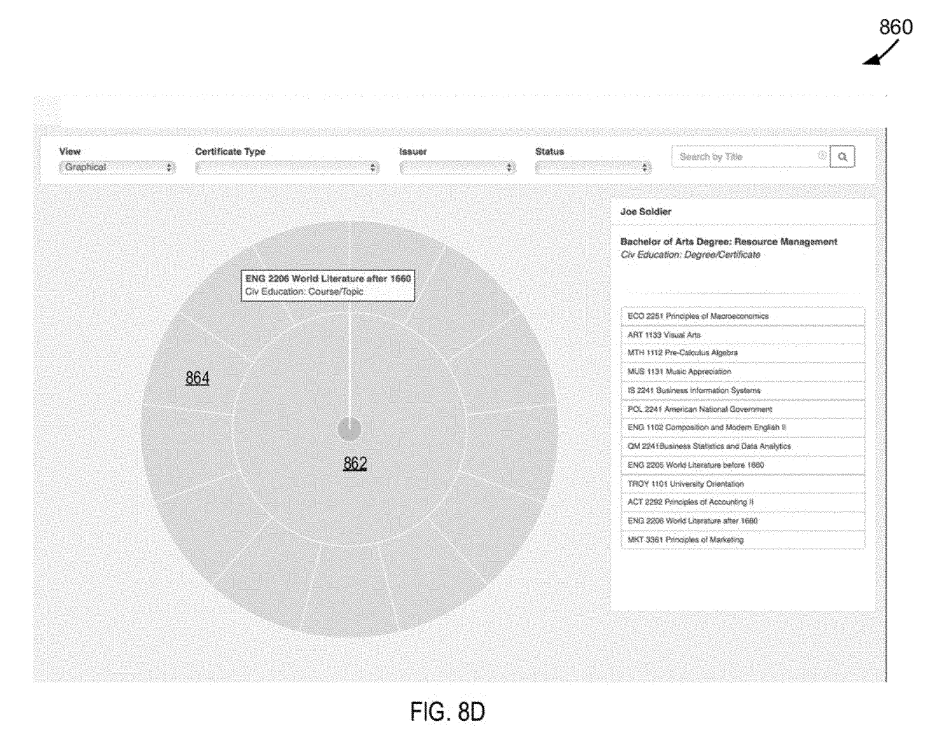

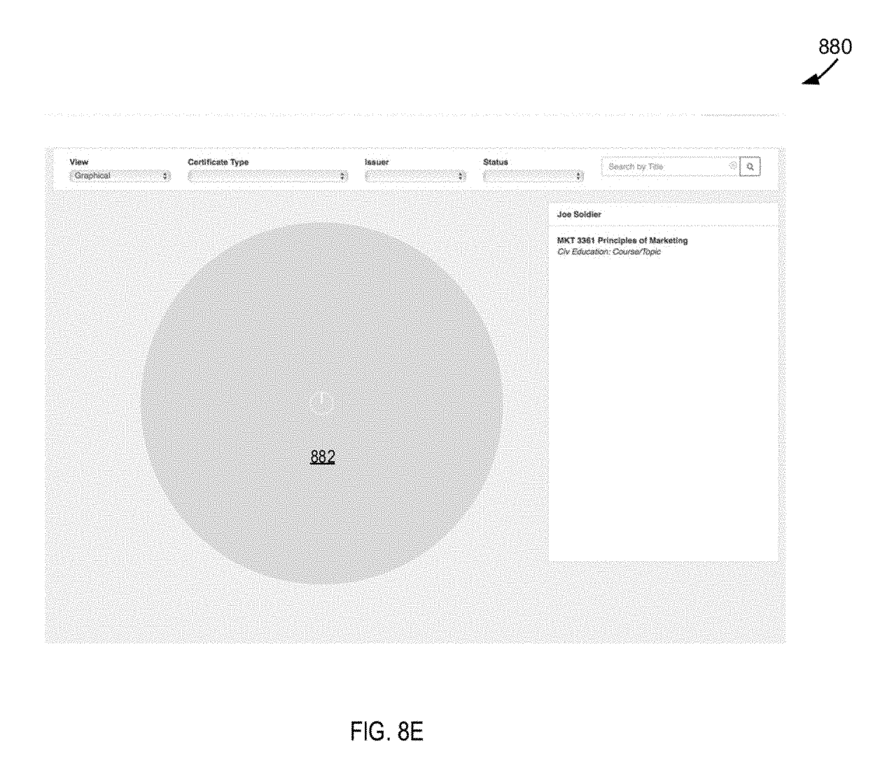

FIG. 8A depicts an example unified graphical user interface (GUI) 800 according to some embodiments. More specifically, the unified GUI 800 depicts relationships (e.g., dynamic relationships) between certificates in a single unified interface. The unified GUI 800 may be generated at least in part by the aggregator system 102 (e.g., by the interface server engine 319).

In the example GUI 800, each certificate is depicted as a two-dimensional arc that is a subsection of one of several concentric rings. The individual arc subsections are arranged in a radial manner so that relationships are depicted through the adjacency of the arc subsections, with certificates depicted in an inner rings being superior in relationship to the certificates in the next outer ring. Reciprocally, arc sections in a more outer ring are subordinate to arc sections adjacent in a more inner ring. In this manner, relationships between certificates may be depicted with any number of orders of relationships.

In some embodiments, the GUI 800 may be interactive to present detail regarding each certificate. Positioning the cursor on any of the arc subsections causes a window to appear with information regarding the certificate, such as a brief description or other information.

The GUI 800 may be interactive to present subsets of the total collection of certificates. Clicking on any arc section may cause it to be depicted by the center circle of the concentric rings, with only the subordinate related certificates depicted as arcs in the adjacent outer ring, and subordinate related certificates depicted as adjacent arcs in the sequentially next most outer ring, with this pattern continuing in the tiers of related subordinate arcs to the lowest subordinate level of the subset of the collection of related certificates. Clicking on the center circle rearranges the related arcs so that the superior certificates are now shown in the next inner ring, and the related subordinate certificates are depicted as adjacent in the next most outer rings.

In a variation of the interface, the total collection of certificates may be represented with the inner circle representing the individual associated with the collection of certificates. The first concentric ring may be composed of subsection arcs, each representing an entity which awarded a subset of the collection of digital, with the related certificates depicted as adjacent subsection arcs in the concentric circles which surround the inner ring. Clicking on any subsection arc can place it at the center circle of the concentric rings. Clicking on the center circle will add one level to the superior to subordinate order, until the interfaces returns to depict the individual at the center.

Colors of individual arcs may be used to depict different relationships, such as the source of the certificate, or the type of accomplishment documented by the certificate.

In the example of FIG. 8A, the inner portion 802 represents a particular learner (e.g., Joe Soldier), and a portion 804 of the second order ring of the GUI 800 represents a particular issuer (e.g., Ashford University).

FIG. 8B depicts an example unified graphical user interface (GUI) 820 according to some embodiments. More specifically, the unified GUI 820 depicts an example interface generated in response to selecting, or otherwise interacting with, the portion 804 of the GUI 800. The GUI 820 may be referred to as a “drill-down” of the GUI 800.

In the example of FIG. 8B, the inner portion 822 represents a particular issuer (e.g., Ashford University), and a portion 824 (e.g., in this case a whole portion) of the GUI 820 represents a certificate (e.g., Master of Arts Degree in Organization Management (MA)) offered by the particular issuer.

FIG. 8C depicts an example unified graphical user interface (GUI) 840 according to some embodiments. More specifically, the unified GUI 840 depicts an example interface generated in response to selecting, or otherwise interacting with, the portion 824 of the GUI 820. The GUI 840 may be referred to as a “drill-down” of the GUI 820.

In the example of FIG. 8C, the inner portion 842 represents a particular certificate (e.g., Master of Arts Degree in Organization Management (MA)), and a portion 844 of the GUI 840 represents a subordinate certificate (e.g., Bachelor of Arts Degree: Resource Management) of the certificate represented by the portion 844.

FIG. 8D depicts an example unified graphical user interface (GUI) 860 according to some embodiments. More specifically, the unified GUI 860 depicts an example interface generated in response to selecting, or otherwise interacting with, the portion 844 of the GUI 840. The GUI 860 may be referred to as a “drill-down” of the GUI 840.

In the example of FIG. 8D, the inner portion 862 represents a particular certificate (e.g., Bachelor of Arts Degree: Resource Management), and a portion 864 of the GUI 860 represents a subordinate certificate (e.g., MKT 3361: Principles of Marketing) of the certificate represented by the portion 864.

FIG. 8E depicts an example unified graphical user interface (GUI) 880 according to some embodiments. More specifically, the unified GUI 880 depicts an example interface generated in response to selecting, or otherwise interacting with, the portion 864 of the GUI 860. The GUI 880 may be referred to as a “drill-down” of the GUI 860. In the example of FIG. 8D, the portion 882 represents a particular certificate (e.g., MKT 3361: Principles of Marketing).

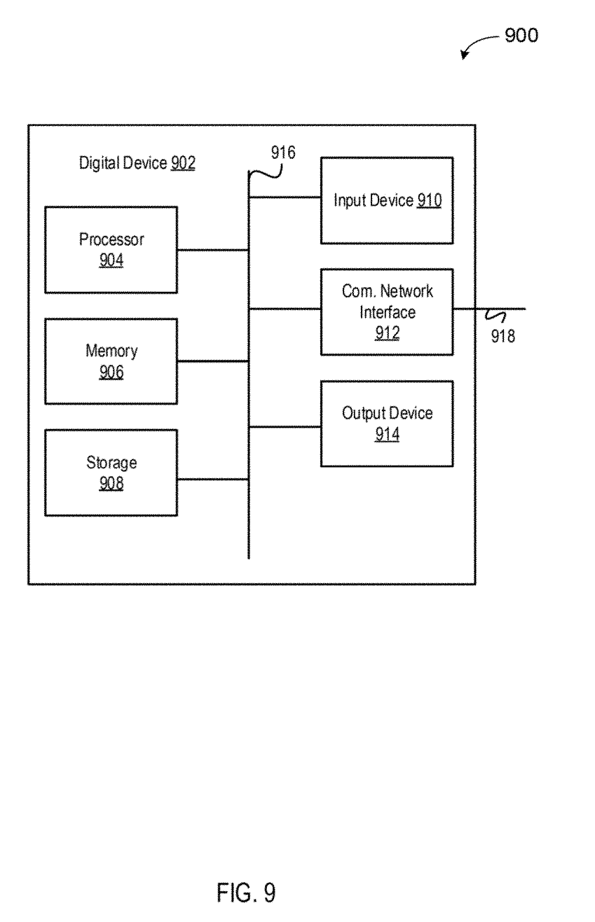

FIG. 9 depicts a diagram 900 of an example of a computing device 902. Any of the issuer systems 102, the aggregator system 104, the learner systems 106, the recipient systems 108, and the communication network 110 may comprise an instance of one or more computing devices 902. The computing device 902 comprises a processor 904, memory 906, storage 908, an input device 910, a communication network interface 912, and an output device 914 communicatively coupled to a communication channel 916. The processor 904 is configured to execute executable instructions (e.g., programs). In some embodiments, the processor 904 comprises circuitry or any processor capable of processing the executable instructions.

The memory 906 stores data. Some examples of memory 906 include storage devices, such as RAM, ROM, RAM cache, virtual memory, etc. In various embodiments, working data is stored within the memory 906. The data within the memory 906 may be cleared or ultimately transferred to the storage 908.

The storage 908 includes any storage configured to retrieve and store data. Some examples of the storage 908 include flash drives, hard drives, optical drives, cloud storage, and/or magnetic tape. Each of the memory system 906 and the storage system 908 comprises a computer-readable medium, which stores instructions or programs executable by processor 904.

The input device 910 is any device that inputs data (e.g., mouse and keyboard). The output device 914 outputs data (e.g., a speaker or display). It will be appreciated that the storage 908, input device 910, and output device 914 may be optional. For example, the routers/switchers may comprise the processor 904 and memory 906 as well as a device to receive and output data (e.g., the communication network interface 912 and/or the output device 914).

The communication network interface 912 may be coupled to a network (e.g., network 110) via the link 918. The communication network interface 912 may support communication over an Ethernet connection, a serial connection, a parallel connection, and/or an ATA connection. The communication network interface 912 may also support wireless communication (e.g., 802.11 a/b/g/n, WiMax, LTE, WiFi). It will be apparent that the communication network interface 912 may support many wired and wireless standards.

It will be appreciated that the hardware elements of the computing device 902 are not limited to those depicted in FIG. 9. A computing device 902 may comprise more or less hardware, software and/or firmware components than those depicted (e.g., drivers, operating systems, touch screens, biometric analyzers, and/or the like). Further, hardware elements may share functionality and still be within various embodiments described herein. In one example, encoding and/or decoding may be performed by the processor 904 and/or a co-processor located on a GPU (i.e., NVidia).

It will be appreciated that an “engine,” “system,” “datastore,” and/or “database” may comprise software, hardware, firmware, and/or circuitry. In one example, one or more software programs comprising instructions capable of being executable by a processor may perform one or more of the functions of the engines, datastores, databases, or systems described herein. In another example, circuitry may perform the same or similar functions. Alternative embodiments may comprise more, less, or functionally equivalent engines, systems, datastores, or databases, and still be within the scope of present embodiments. For example, the functionality of the various systems, engines, datastores, and/or databases may be combined or divided differently. The datastore or database may include cloud storage. It will further be appreciated that the term “or,” as used herein, may be construed in either an inclusive or exclusive sense. Moreover, plural instances may be provided for resources, operations, or structures described herein as a single instance. It will be appreciated that any of the systems described herein may comprise existing systems (e.g., controlled by one or more third-parties) and/or comprise systems controlled by one or more centralized systems (e.g., a central server system).

The present invention(s) are described above with reference to example embodiments. It will be apparent to those skilled in the art that various modifications may be made and other embodiments may be used without departing from the broader scope of the present invention(s). Therefore, these and other variations upon the example embodiments are intended to be covered by the present invention(s).

1. A system comprising:
one or more processors; and
memory storing instructions that, when executed by the one or more processors, cause the system to perform:
storing a plurality of certificate catalogues, each certificate catalogue comprising one or more certificate templates, each certificate catalogue associated with a respective issuer;
storing a plurality of certificate data records, each certificate data record of the plurality of certificate data records identifying a learner and a learning outcome, each certificate data record of the plurality of certificate data records being generated based on a corresponding certificate template;
obtaining a certificate plan, the certificate plan comprising a set of one or more particular certificate templates;
comparing the certificate plan and a portion of the plurality of certificate data records, the portion of the plurality of certificate data records comprising the certificate data records identifying a particular learner;
determining one or more gaps in the certificate plan based on the comparison; and
presenting, through a graphical user interface, the one or more gaps in the certificate plan.

2. The system of claim 1, wherein a first portion of the certificate data records identifying the particular learner are associated with a first issuer, and a second portion of the certificate data records identifying the particular learner are associated with a second issuer.

3. The system of claim 1, wherein each of the plurality of certificate data records comprises a respective data structure, each respective data structure including one or more parameters to facilitate generation of a corresponding certificate, and at least a portion of the respective data structures including an indication of any of one or more parent certificate data records and one or more child certificate data records.

4. The system of claim 3, wherein the instructions further cause the system to perform:
identifying a particular certificate data record of the plurality of certificate data records;
generating a particular certificate based on the particular certificate data record, the particular certificate indicating a particular learner and a particular learning outcome, and including a first link to the particular certificate data record, and including a second or more links to particular child or parent certificate data records of the of the particular certificate data record;
based on the particular data record, creating a link between the particular certificate data record and any previously existing relevant data records specified in the particular data record and
providing the particular certificate to a learner system associated with the particular learner.

5. The system of claim 4, wherein the particular certificate is immutable.

6. The system of claim 4, wherein the first link and the second link each comprise a respective permanent link.

7. The system of claim 4, wherein the instructions further cause the system to perform:
receiving a request for a profile of the particular learner;
organizing, in response to the request for the profile of the particular learner, at least a portion of the plurality of certificate data records based upon any of the indicated child certificate data records and the indicated parent certificate data records of the one or more certificate data records identifying the particular learner;
generating, in response to the organizing at least the portion of plurality of certificate data records, the profile of the particular learner; and
presenting the profile of the particular learner.

8. The system of claim 7, wherein the profile of the particular learner includes a representation of the certificate plan.

9. The system of claim 8, wherein the profile of the particular learner includes a representation of the one or more gaps of the certificate plan.

10. A method implemented by a computing system including one or more physical processors and storage media storing machine-readable instructions, the method comprising:
storing a plurality of certificate catalogues, each certificate catalogue comprising one or more certificate templates, each certificate catalogue associated with a respective issuer;
storing a plurality of certificate data records, each certificate data record of the plurality of certificate data records identifying a learner and a learning outcome, each certificate data record of the plurality of certificate data records being generated based on a corresponding certificate template;
obtaining a certificate plan, the certificate plan comprising a set of one or more particular certificate templates;
comparing the certificate plan and a portion of the plurality of certificate data records, the portion of the plurality of certificate data records comprising the certificate data records identifying a particular learner;
determining one or more gaps in the certificate plan based on the comparison; and presenting, through a graphical user interface, the one or more gaps in the certificate plan.

11. The method of claim 10, wherein a first portion of the certificate data records identifying the particular learner are associated with a first issuer, and a second portion of the certificate data records identifying the particular learner are associated with a second issuer.

12. The method of claim 10, wherein each of the plurality of certificate data records comprises a respective data structure, each respective data structure including one or more parameters to facilitate generation of a corresponding certificate, and at least a portion of the respective data structures including an indication of any of one or more parent certificate data records and one or more child certificate data records.

13. The method of claim 12, further comprising:
identifying a particular certificate data record of the plurality of certificate data records;
generating a particular certificate based on the particular certificate data record, the particular certificate indicating a particular learner and a particular learning outcome, and including a first link to the particular certificate data record, and including a second or more links to particular child or parent certificate data records of the of the particular certificate data record; and
providing the particular certificate to a learner system associated with the particular learner.

14. The method of claim 13, wherein the particular certificate is immutable.

15. The method of claim 13, wherein the first link and the second link each comprise a respective permanent link.

16. The method of claim 13, further comprising:
receiving a request for a profile of the particular learner;
organizing, in response to the request for the profile of the particular learner, at least a portion of the plurality of certificate data records based upon any of the indicated child certificate data records and the indicated parent certificate data records of the one or more certificate data records identifying the particular learner;
generating, in response to the organizing at least the portion of plurality of certificate data records, the profile of the particular learner; and
presenting the profile of the particular learner.

17. The method of claim 16, wherein the profile of the particular learner includes a representation of the certificate plan.

18. The method of claim 17, wherein the profile of the particular learner includes a representation of the one or more gaps of the certificate plan.

19. A non-transitory computer readable medium comprising instructions that, when executed, cause one or more processors to perform:
storing a plurality of certificate catalogues, each certificate catalogue comprising one or more certificate templates, each certificate catalogue associated with a respective issuer;
storing a plurality of certificate data records, each certificate data record of the plurality of certificate data records identifying a learner and a learning outcome, each certificate data record of the plurality of certificate data records being generated based on a corresponding certificate template;
obtaining a certificate plan, the certificate plan comprising a set of one or more particular certificate templates;
comparing the certificate plan and a portion of the plurality of certificate data records, the portion of the plurality of certificate data records comprising the certificate data records identifying a particular learner;
determining one or more gaps in the certificate plan based on the comparison; and
presenting, through a graphical user interface, the one or more gaps in the certificate plan.

20. The non-transitory computer readable medium of claim 19, wherein each of the plurality of certificate data records comprises a respective data structure, each respective data structure including one or more parameters to facilitate generation of a corresponding certificate, and at least a portion of the respective data structures including an indication of any of one or more parent certificate data records and one or more child certificate data records.
